(19) United States
(12) Patent Application Publication
(10) Pub. No.: US 2017/0298688 A1
(43) Pub. Date: Oct. 19, 2017

(54) SPRING BOX OF CORDLESS WINDOW COVERING AND FRICTION MECHANISM OF THE SAME

(71) Applicant: NIEN MADE ENTERPRISE CO., LTD., Taichung City (TW)

(72) Inventors: Lin CHEN, Taichung (TW); Keng-Hao NIEN, Taichung (TW)

(21) Appl. No.: 15/253,557

(22) Filed: Aug. 31, 2016

(30) Foreign Application Priority Data
Apr. 19, 2016 (CN) 201620327016.8

(51) Int. Cl. E06B 9/322; F03G 1/00; E06B 9/262

(52) U.S. Cl. CPC E06B 9/322; F03G 1/00; E06B 9/262; E06B 2009/2627; E06B 2009/3222

(57) ABSTRACT

A spring box provided in one headrail of a window covering is disclosed, including a base, a post rotatably provided on the base to wind up a lifting cord, and a prestressing device which provides a pulling force to the post to rotate it in a predetermined direction. The spring box further includes a guiding member provided in the post to be rotated by the post, a movable member which moves along the guiding member in a non-rotating manner when the guiding member is rotated, and a friction member which is compressed and deformed to increase a friction between it and an inner wall of the post when the movable member is moved in a predetermined direction, providing a resistance effect to the rotation of the post, which makes one bottom rail of the window covering stay at a predetermined position.

### BACKGROUND OF THE INVENTION

### 1. Technical Field

The present invention relates generally to a window covering, and more particularly to a spring box of a cordless window covering and a friction mechanism thereof.

### 2. Description of Related Art

A conventional cordless window covering usually uses an automatic reeling device, e.g., a spring box, to move the bottom rail relative to the headrail, so as to expand or raise the shield structure of the window covering.

Such shield structure is typically made of a continuous material, and the common types include cellular shade and pleated shade, which are both stretchable. Take a cellular shade as an example, the blanket has multiple horizontal tubes, which allow the blanket to be expanded or raised vertically. The stacked blanket would have a compact size. With these stretchable tubes, the blanket has abundant flexibility to be expanded or raised. However, when the blanket is just fully expanded, the bottom rail tends to rebound due to the effect of the stretchable tubes. Also, the pulling force provided by the torsion spring in the automatic reeling device would further make the bottom rail rebound. On the other hand, the blanket may not be able to be completely raised even if user intends to do so, for the blanket would exert a downward pushing force on the bottom rail to make the blanket always slightly expanded.

To ensure the bottom rail to simply stay at the lowest position when the blanket is fully expanded, a conventional solution is to provide a counterweight structure at the bottom rail to suppress the rebounding. However, such a window covering would be heavy, and therefore, would be not easy to operate. In addition, a heavier bottom rail would worsen the latter problem mentioned above, that the blanket may not be able to be completely raised.

### BRIEF SUMMARY OF THE INVENTION

In view of the above, the primary objective of the present invention is to provide a spring box of a cordless window covering, which has a friction mechanism to ensure that the bottom rail of the window covering simply stays at a predetermined position.

The present invention provides a spring box of a cordless window covering, wherein the spring box is provided in one rail of the window covering. The spring box includes a base, a post, a prestressing device, a guiding member, a movable member, and a friction member. The post is rotatably connected to the base. The prestressing device provides a pulling force to the post to rotate the post in a predetermined rotation direction. The guiding member is rotatable by the post. The movable member fits around the guiding member, wherein the movable member moves along the guiding member when the guiding member is rotated. The friction member is connected to the movable member, wherein the friction member has at least one effect portion abutting against a wall of the post; while the movable member is being moved in a predetermined direction, the at least one effect portion pushes the wall of the post harder, whereby a friction between the at least one effect portion and the wall of the post is increased.

In an embodiment, the post is a hollow tube, and has a top plate. The guiding member comprises a bolt passing through the post, wherein a top of the bolt is connected to the top plate of the post, while a bottom of the bolt is rotatably and pivotally provided on the base. The movable member is provided in the post, and has a threaded hole being passed through by the bolt.

In an embodiment, the spring box further includes at least one restricting member provided in the post, wherein an end of each of the at least one restricting member is connected to the base, and each of the at least one restricting member is in parallel with the bolt. The at least one restricting member abuts against the movable member, so that the movable member moves along the bolt in a non-rotating manner when the bolt is rotated.

In an embodiment, the top plate of the post has a non-circular hole. A top of the bolt is provided with a non-circular head inserting into the non-circular hole of the top plate to be connected to the top plate.

In an embodiment, an inner wall of the post has a tapered segment, of which a diameter gradually reduces. When the movable member is moved to a top edge of the tapered segment, the friction member is compressed and deformed; when the movable member is moved to a bottom edge of the tapered segment, the friction member returns to an original status.

In an embodiment, the friction member fits around the guiding member. The at least one effect portion of the friction member comprises two effect portions, wherein one of the effect portions abuts against a lateral side of the movable member, while the other one of the effect portions abuts against the inner wall of the post.

In an embodiment, the post is in parallel with the guiding member. The guiding member comprises a bolt. A top of the bolt is connected to a top of the post, while a bottom of the bolt is rotatably and pivotally provided on the base. The movable member has a threaded hole being passed through by the bolt.

In an embodiment, the spring box further includes at least one restricting member adjacent to the bolt, wherein an end of each of the at least one restricting member is connected to the base, and each of the at least one restricting member is in parallel to the bolt. The at least one restricting member abuts against the movable member, so that the movable member moves along the bolt in a non-rotating manner when the bolt is rotated.

In an embodiment, an outer surface of the post has a tapered segment, of which a diameter gradually increases. When the movable member is moved to where the diameter of the tapered segment is greatest, the friction member is compressed and deformed; when the movable member is moved to where the diameter of the tapered segment is smallest, the friction member returns to an original status.

In an embodiment, the friction member comprises a pushing block and at least one elastic member. The pushing block is detachably engaged with the movable member, and has the effect portion. The at least one elastic member is provided between the pushing block and the movable member, and is deformable by compression.

In an embodiment, the movable member has an engaging portion. The at least one effect portion of the friction member comprises two effect portions, wherein one of the effect portions is engaged with the engaging portion, while the other one of the effect portions abuts against the wall of the post.

The present invention further provides a resistance structure, including a base, a post rotatably connected to the base, a bolt movable by the post, a movable member having a threaded hole being passed through by the bolt, a restricting member provided on the base, and a friction member connected to the movable member. The restricting member abuts against the movable member, so that the movable member moves relatively along the bolt when the bolt is rotated. The friction member has at least one effect portion abutting against a wall of the post. While the movable member is being moved in a predetermined direction, the at least one effect portion pushes the wall of the post harder, whereby a friction between the at least one effect portion and the wall of the post is increased.

By changing the position of the movable members, the friction members could be further compressed and deformed, wherein the deformed friction members would provide higher friction between the friction members and the corresponding inner wall of the tubular posts, which helps the bottom rail of the window covering to simply stay at the predetermined position.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the cordless window covering including the spring box of the first embodiment of the present invention;

FIG. 2 is a perspective view of the spring box disclosed in FIG. 1;

FIG. 3 is an exploded view of FIG. 2;

FIG. 4 is a front view of part of the components of the spring box disclosed in FIG. 1;

FIG. 5 is a longitudinal sectional view of FIG. 4, showing the lifting cord is wound up;

FIG. 6 is a transverse sectional view of FIG. 4, showing the friction members are at its original status;

FIG. 7 is a perspective view of the movable member and the friction members in the spring box of the first embodiment;

FIG. 8 is similar to FIG. 5, showing the lifting cord is released;

FIG. 9 is similar to FIG. 6, showing the friction members are compressed and deformed;

FIG. 10 is an exploded view of part of the components of the spring box of a second embodiment of the present invention;

FIG. 11 is a longitudinal sectional view of the components illustrated in FIG. 10;

FIG. 12 is a perspective view of the spring box of a third embodiment of the present invention;

FIG. 13 is an exploded view of par of the components of the spring box illustrated in FIG. 12;

FIG. 14 is a front view of part of the components of the spring box illustrated in FIG. 12, showing the lifting cord is wound up;

FIG. 15 is a top view of FIG. 14; and

FIG. 16 is similar to FIG. 14, showing the lifting cord is released.

### DETAILED DESCRIPTION OF THE INVENTION

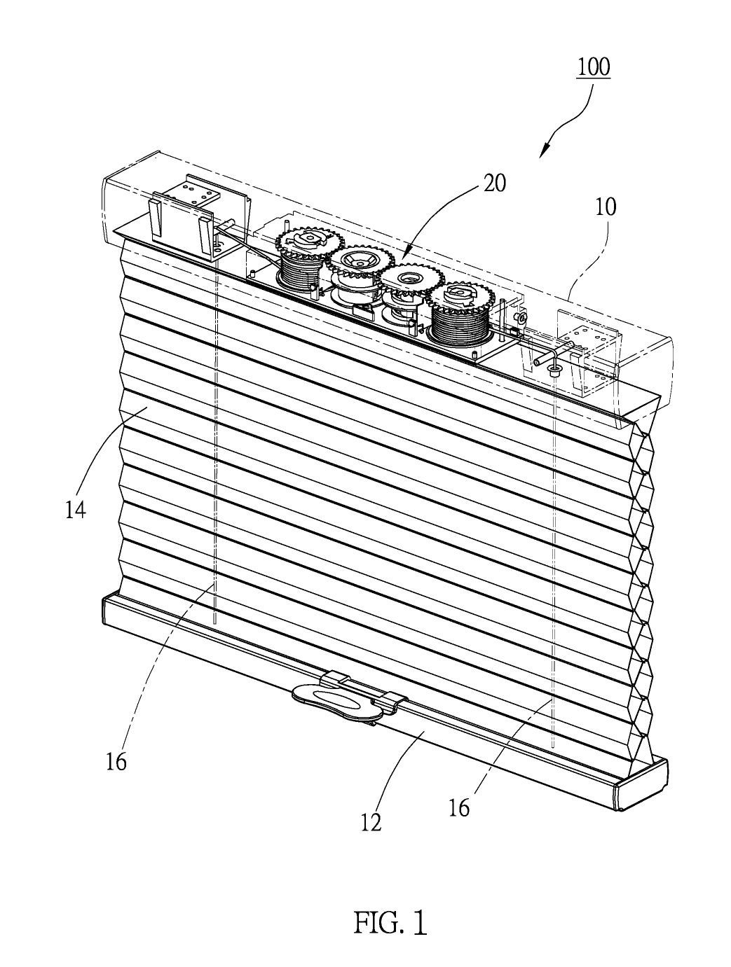

A fully expanded cordless window covering 100, which includes a spring box of the first embodiment of the present invention, is illustrated in FIG. 1, wherein the cordless window covering 100 includes two rails, which are a headrail 10 and a bottom rail 12, a shield structure 14, and two lifting cords 16. Two ends of the shield structure 14 are respectively connected to the headrail 10 and the bottom rail 12, and is a cellular shade in the first embodiment as an example. An end of each of the lifting cords 16 is fixedly connected to the bottom rail 12, while another end thereof is connected to the spring box provided in the headrail 10.

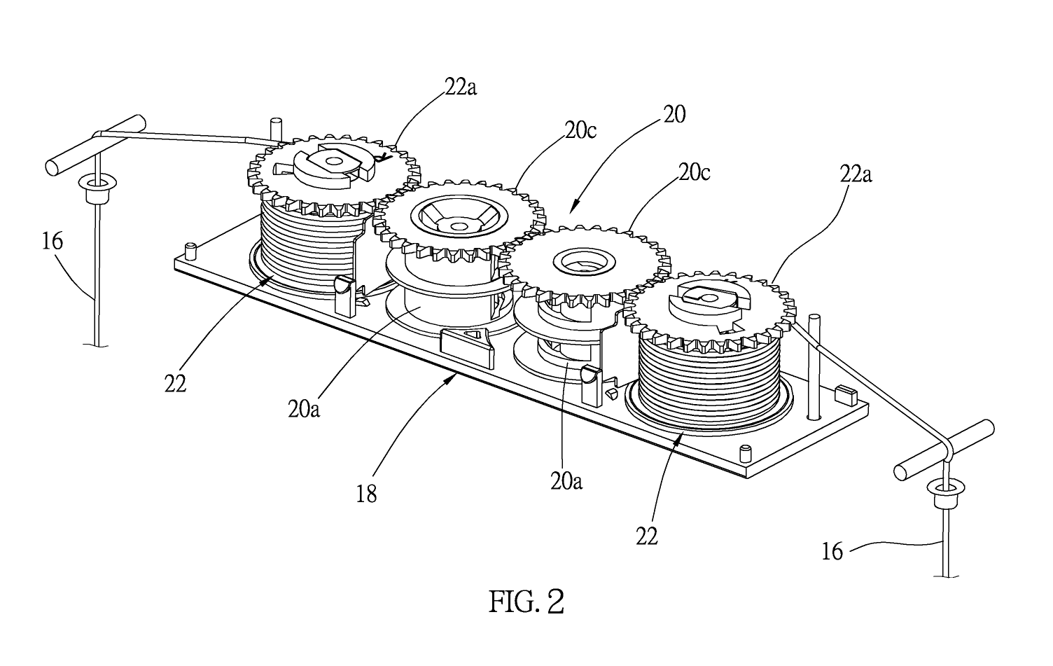

The condition of the spring box when the cordless window covering 100 is raised is illustrated in FIG. 2 to FIG. 5, wherein the spring box includes a base 18, a prestressing device 20, and two posts 22.

The base 18 is substantially a plate, and is firmly fixed in the headrail 10, with the prestressing device 20 and the posts 22 provided thereon. The prestressing device 20 is composed of two drums 20a and two torsion springs (not shown). Each of the drums 20a has a gear 20c connected to a top thereof, wherein the gears 20c of the drums 20a mesh with each other. The torsion springs are arranged with one above the other, and two ends of each of the torsion springs are respectively connected to one of the drums 20a. More specifically, the torsion springs mostly wind around one of the drums 20a in a normal condition, and are gradually shifted to wind around the other one of the drums 20a when the drums 20a are turned. Said normal condition refers to the raised status of the cordless window covering 100, i.e., when the bottom rail 12 is near the headrail 10. The structure of the prestressing device 20 is quite conventional, and therefore, we are not going to describe it in details herein.

The posts 22 are hollow and tubular, and are provided on two sides of the prestressing device 20, wherein each of the posts 22 is connected to an end of one of the lifting cords 16. A top of each of the posts 22 is respectively connected to a gear 22a, wherein each of the gears 22a meshes with the gear 20c of the adjacent drum 20a. Therefore, the posts 22 could be rotated along with the drums 20a to wind up or to release the connected lifting cords 16, so that the bottom rail 12 could be moved up and down relative to the headrail 10. The cordless window covering 100 could be controlled to be raised or to be expanded in this way. When in the normal condition, each of the lifting cords 16 is respectively wound around one of the posts 22.

As mentioned above, the bottom rail 12 of the cordless window covering 100 could stay at a predetermined position through the pulling force provided by the torsion springs of the prestressing device 20. However, to ensure that the bottom rail 12 simply stays at the right position, the spring box of the first embodiment is further provided with a resistance structure to help the bottom rail 12 to stay at the predetermined position as expected.

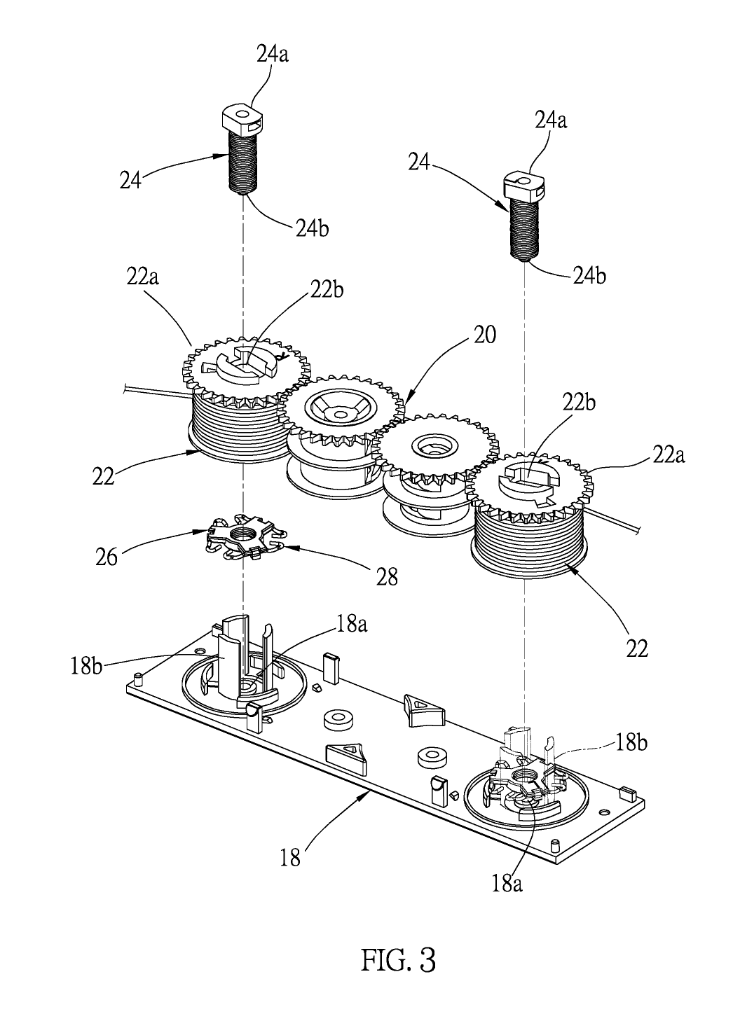

As shown in FIG. 3, the resistance structure of the spring box includes two round holes 18a, which are provided on a surface of the base 18, and a plurality of restricting members 18b, wherein each of the restricting members 18b is integrally formed to surround one of the round holes 18a, and is vertically connected to the surface of the base 18. Furthermore, a non-circular hole 22b is provided on a top plate (i.e., the gear 22a) of each of the posts 22. The resistance structure further includes two guiding members, two movable members 26, and a plurality of friction members 28. For easier understanding, the following description regarding the resistance structure takes one set of the members and one of the rotatable posts 22 for interpretation.

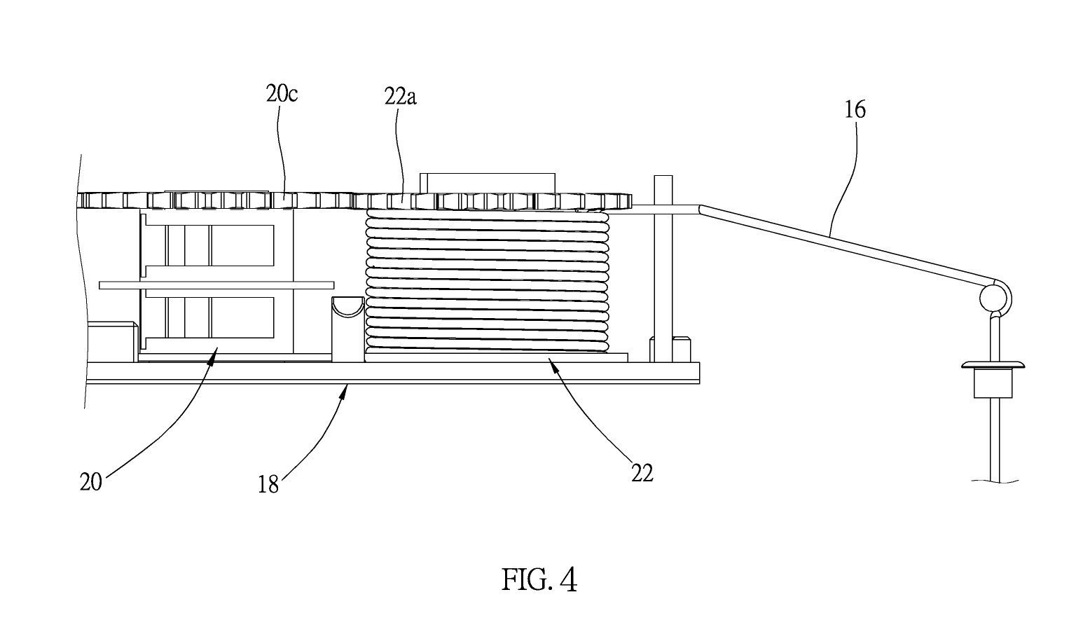

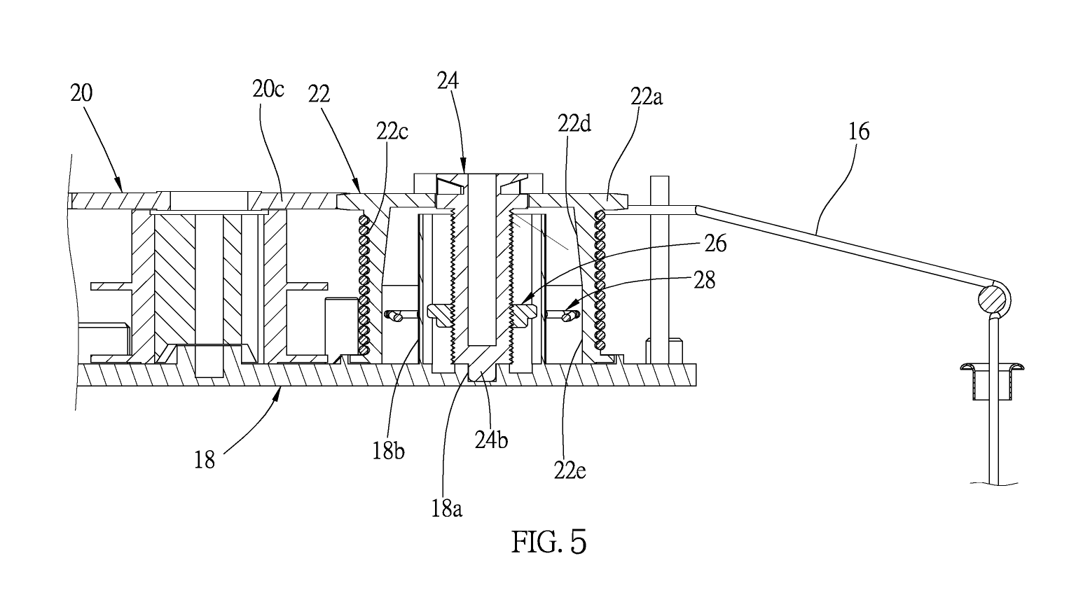

As shown in FIG. 4 and FIG. 5, a cord channel 22c is provided on an outer surface of the post 22 to allow the corresponding lifting cord 16 to be smoothly wound thereon. An inner wall of the post 22 has a tapered segment 22d, of which a diameter gradually increases from top to bottom, and a straight segment 22e being connected to a bottom edge of the tapered segment, wherein a diameter of the straight segment 22e stays constant.

The guiding member is provided in the post 22, and is synchronously rotatable with the post 22 in the same direction. In the first embodiment, the guiding member is a bolt 24 partially surrounded by the restricting members 18b. The bolt 24 has a non-circular head 24a at a top thereof. By inserting the non-circular head 24a into the non-circular hole 22b of the gear 22a of the post 22, the bolt 24 is engaged with the post 22. The bolt 24 has a round protrusion 24b at a bottom thereof, which is inserted into the corresponding round hole 18a of the base 18. In this way, the bolt 24 is in parallel with the restricting members 18b, and is synchronously rotatable along with the post 22 in the same direction. It is worth mentioning that, in addition to providing the matched non-circular head 24a and the non-circular hole 22b, other designs are also acceptable, as long as the bolt 24 and the post 22 are rotatable synchronously in the same direction. For example, in other embodiments, there could be a pin passing through the bolt 24 and the post 22 at the same time. Moreover, in such cases, the bolt 24 is not necessary to have a non-circular head. Alternatively, the bolt 24 and the post 22 could be directly glued together as well.

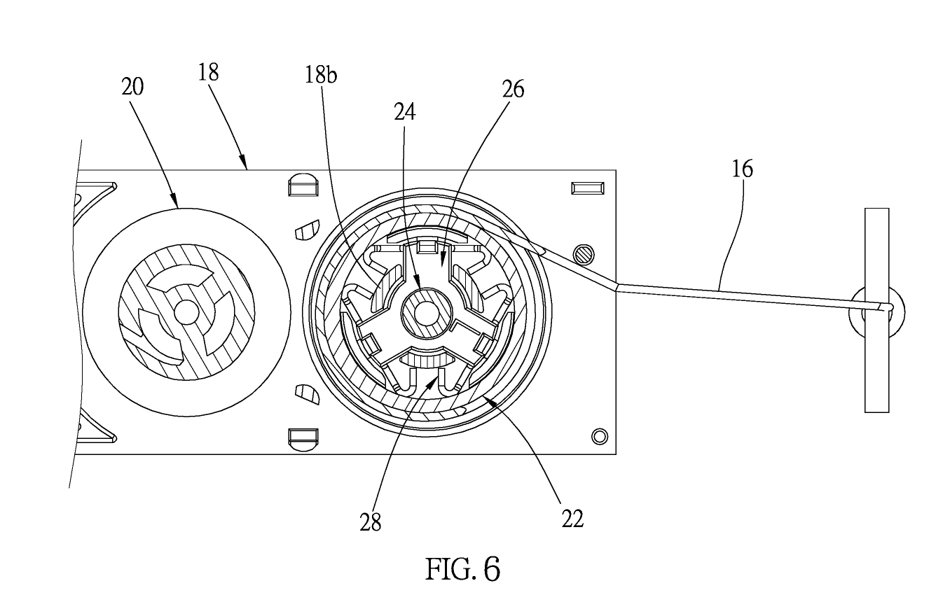

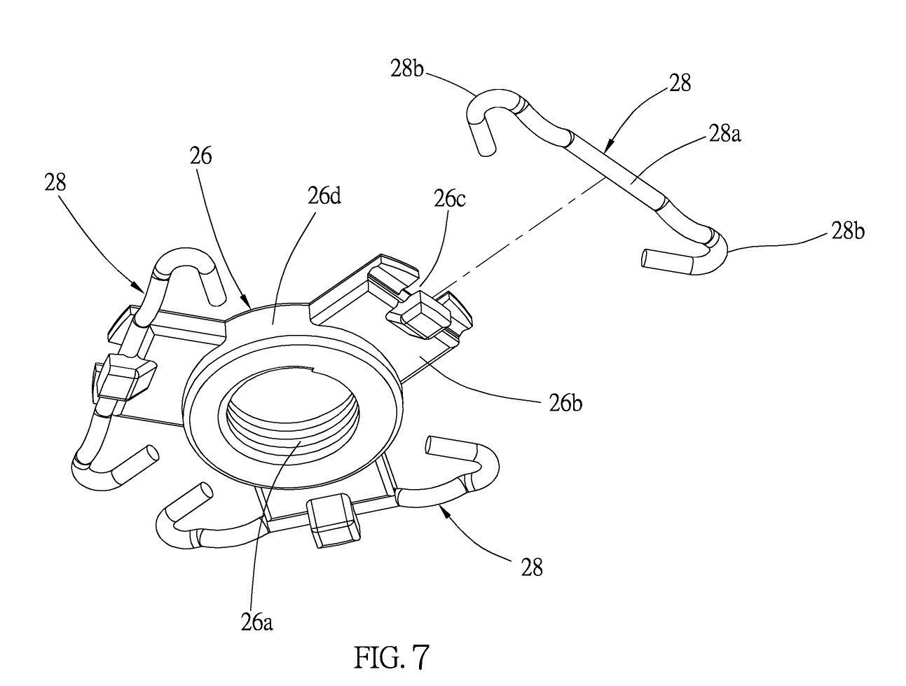

As shown in FIG. 6 and FIG. 7, the movable member 26 has a threaded hole 26a provided in a center thereof to be inserted by the bolt 24, wherein the movable member 26 is positioned in the post 22. The movable member 26 has a plurality of fins 26b arranged in a radial direction thereof, wherein an engaging portion formed by an engaging groove 26c is provided at a front end of each of the fins 26b. Also, an abutting surface 26d is provided between each two adjacent fins 26b. As shown in FIG. 5 and FIG. 6, the movable member 26 is engaged with the bolt 24 through the threaded hole 26a thereof, and each of the abutting surfaces 26d is respectively abutted by one of the restricting members 18b, so that the movable member 26 could move along the bolt 24 in a non-rotating manner when the bolt 24 is rotated. In other words, by rotating the bolt 24 in a clockwise or a counterclockwise direction, the movable member 26 could be moved upward or downward.

Each of the friction members 28 has at least two effect portions, each of which abuts against the movable member 26 and the inner wall of the post 22. In the first embodiment, each of the friction members 28 is made by bending a steel wire, and includes a middle portion 28a and two hook portions 28b, wherein the hook portions 28b are respectively connected to two sides of the middle portion 28a. The middle portion 28a of each of the friction members 28 is engaged into one of the engaging grooves 26c of the movable member 26, becoming one of the effect portions abutting against the movable member 26. On the other hand, the hook portions 28b of each of the friction member 28 become the effect portions abutting against the inner wall of the post 22. As shown in FIG. 6, the friction members 28 are engaged with the movable member 26 in the radial direction of the movable member 26.

The structural relation between the resistance structure of the first embodiment of the present invention and one of the rotatable posts 22 is described above, and how such design could help the bottom rail 12 to stay right at the predetermined position is explained below.

As shown in FIG. 4, when each of the lifting cords 16 is wound around the corresponding post 22, the bottom rail 12 is near the headrail 10, and the torsion springs are in a naturally coiled state. As shown in FIG. 5 and FIG. 6, in this state, the movable members 26 are near the base 18, and the friction members 28 are in the lower part of the corresponding post 22, wherein the hook portions 28b of each of the friction members 28 are close to, or gently abuts against, the straight segment 22e of the inner wall of the corresponding post 22. In other words, the friction members 28 are not deformed at this time.

When the bottom rail 12 is pulled downward to expand the cordless window covering 100, the lifting cords 16 are released from the posts 22 along with the downward movement of the bottom rail 12, causing the posts 22 to rotate. Meanwhile, the naturally coiled torsion springs are shifted to wind around the other one of the drums 20a. Whereby, when the cordless window covering 100 is going to be raised, the pulling force generated due to the automatic rewinding of the torsion springs would help the shield structure 14 to be easily raised.

In the aforementioned condition, when each of the posts 22 is rotated due to the releasing of the corresponding lifting cord 16, the corresponding bolt 24 would be also synchronously rotated in the same direction. At this time, each of the movable members 26 would gradually move upward along with the downward movement of the bottom rail 12, for the corresponding bolt 24 is screwed into the threaded hole 26a thereof, and each of the movable members 26 is not rotatable as being tightly abutted against by the corresponding restricting members 18b. When the bottom rail 12 starts to lower, and before the window covering 100 is semi-expanded, the distance of the upward movement of each of the movable members 26 is still within the straight segment 22e of the inner wall of the corresponding post 22, so that the friction members 28 have not been deformed yet, and therefore, the bottom rail 12 could be easily pulled downward.

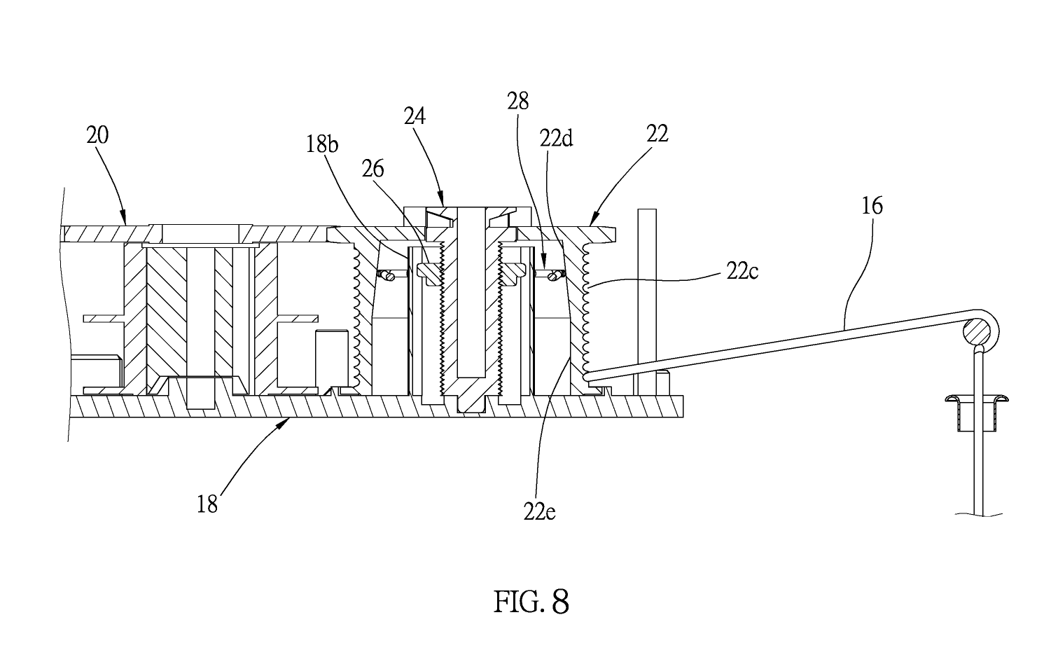

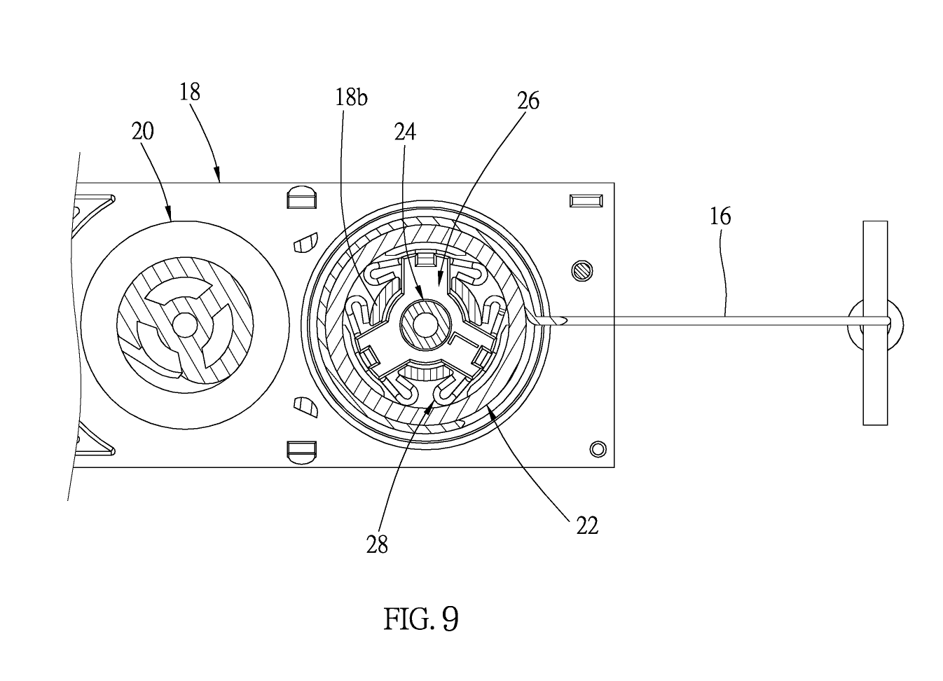

When the bottom rail 12 is lowered around half way to fully expand the window covering 100, each of the movable members 26 starts to reach a junction between the tapered segment 22d and the straight segment 22e of the inner wall of the corresponding post 22. As shown in FIG. 8 and FIG. 9, when the bottom rail 12 is further pulled down, and before the bottom rail 12 reaches a lowest position, the friction members 28 which are moved upward along with the movable members 26 would be compressed and deformed by the corresponding tapered segment 22d, for the diameter of the inner wall of each of the posts 22 decreases upward in the tapered segment 22d. The further the movable member 26 is moved upward, the more the friction members 28 get deformed, whereby the friction between the friction members 28 and the inner wall of the corresponding post 22 would keep increasing, until the bottom rail 12 reaches the lowest position. And when the bottom rail 12 is at the lowest position, the pulling force provided by the torsion springs would stop the bottom rail 12; furthermore, the friction between the deformed friction members 28 and the posts 22 would suppress the pulling force generated by the tendency of the torsion springs to automatic rewind, and would suppress the possible re-bouncing force of the shield structure 14 as well. Whereby, the bottom rail 12 could simply and precisely stay at the predetermined position.

On the contrary, thanks to the pulling force generated by the automatic rewinding of the torsion springs, when the bottom rail 12 is pushed upward to raise the cordless window covering 100, such operation would be effortless. While each of the posts 22 is changing its rotating direction and winding up the corresponding lifting cord 16, the corresponding movable member 26 would be moved downward again, for the corresponding bolt 24 is also rotated reversely. The friction members 28 would return to their original state after each of the movable members 26 passing a bottom edge of the tapered segment 22d of the inner wall of the corresponding post 22. After that, the posts 22 are no longer affected by friction, and therefore, the lifting cords 16 could be wound up smoothly.

In the aforementioned embodiment, the resistance effect on the rotating posts 22 is provided by the plurality of friction members 28 arranged on the radial direction of the movable members 26. In practice, the friction members and the movable members could be also integrally made. For example, by using deformable materials such as plastic or metals, ends of each of the movable members corresponding to the inner wall of the corresponding post could directly become the aforementioned effect portions of the friction members, which could also exert variable stress on the inner wall of the corresponding post to change the magnitude of friction, generating the required resistance effect.

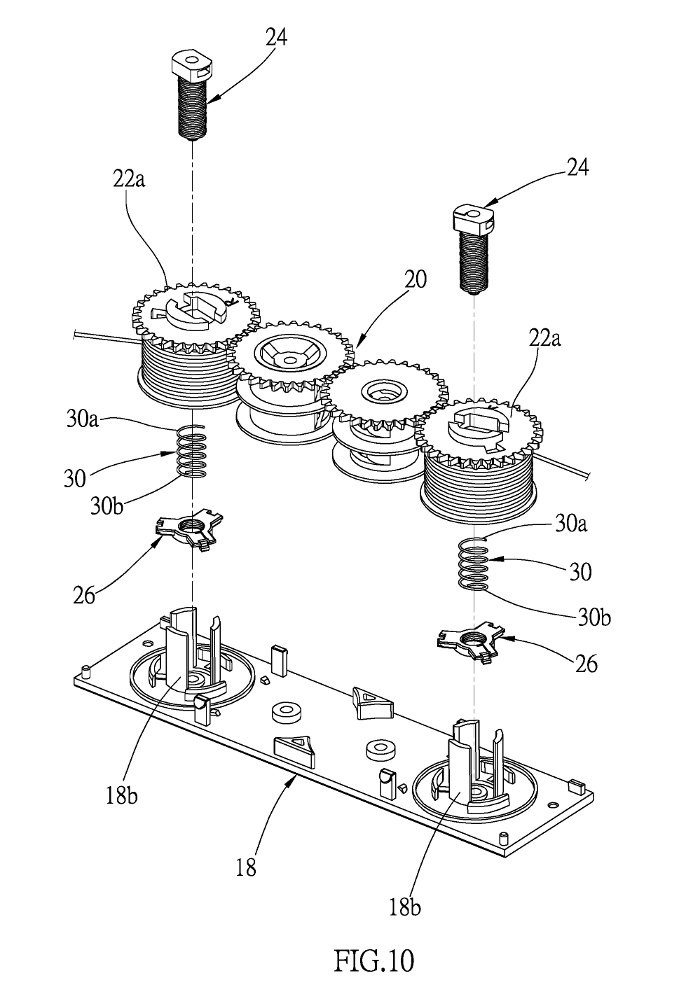

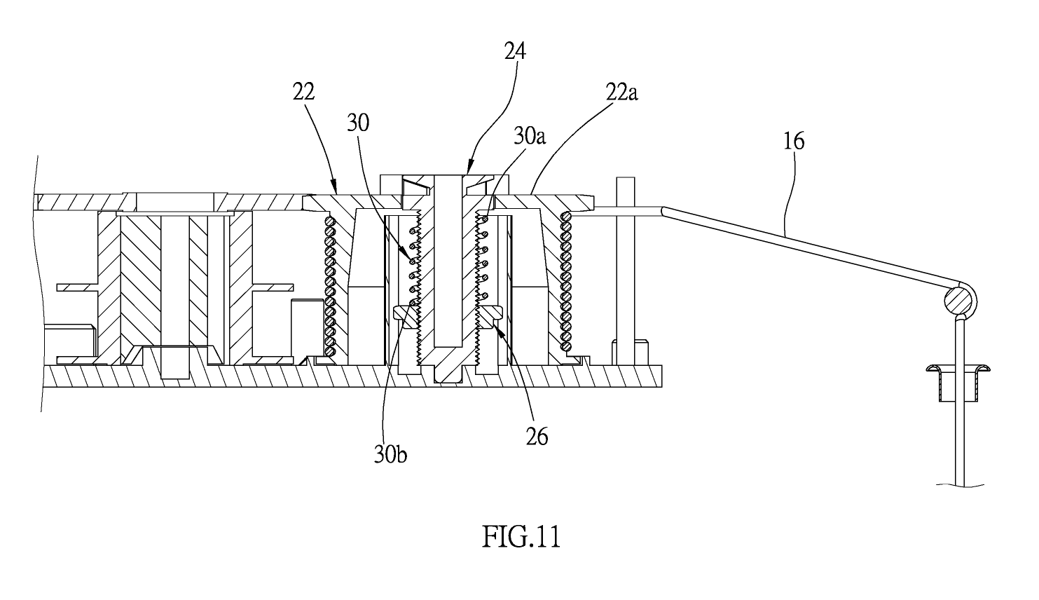

In addition, on the promise of providing the same effect, a second embodiment is further illustrated in FIG. 10 and FIG. 11, wherein each of friction members 30 is helical, and fits around one of the bolts 24. Each of the friction members 30 has two opposite effect portions 30a, 30b, wherein one of the effect portions (30a) abuts against an inner surface of the gear 22a of the corresponding post 22, while the other one of the effect portions (30b) abuts against a top surface of the corresponding movable member 26. The friction members 30 are required to start being compressed when the bottom rail 12 is lowered around half way to fully expand the window covering. In this way, while the bottom rail 12 is further moved toward the lowest position, the friction members 30 would be gradually more compressed to provide higher friction on the inner side of the gear 22a of each of the posts 22, which dampens the rotating posts 22. Of course, if necessary, each fin 26b of each of the movable members 26 could be further provided with one friction member (i.e., the friction member 28) thereon to provide an even higher resistance effect. In addition, since the friction members 30 are helical in the second embodiment, the inner wall of each of the posts 22 is not necessary to include a tapered segment. In other words, even if the inner wall of each of the posts 22 has a constant diameter, the effect of the friction members 30 would not be affected.

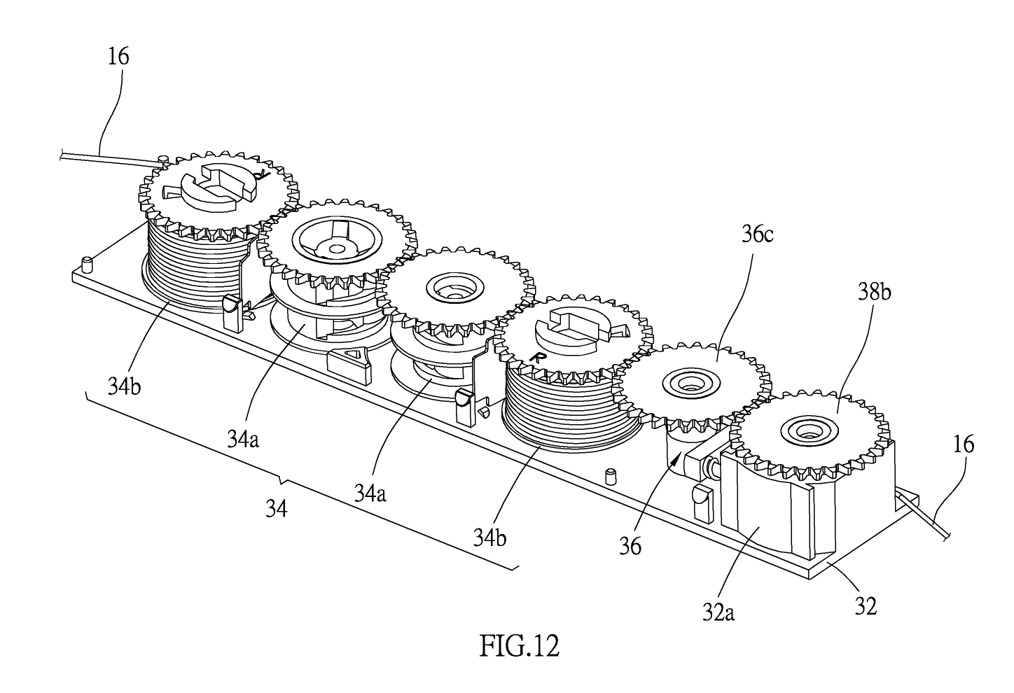

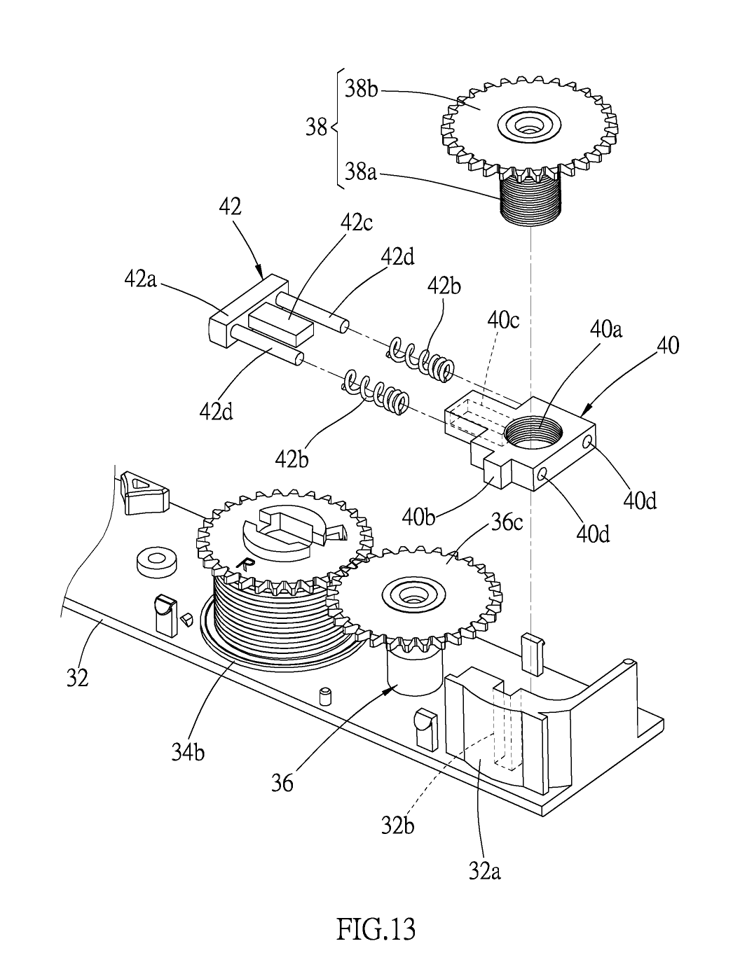

In addition, a spring box of a third embodiment of the present invention is illustrated in FIG. 12 and FIG. 13, wherein the spring box includes a base 32 and a prestressing device 34. The base 32 has a restricting member provided on a side thereof, wherein the restring member is a restricting wall 32a in the third embodiment. The restricting wall 32a has a vertical groove 32b on an inner surface thereof. The prestressing device 34 includes two drums 34a, two torsion springs (not shown) and two spools 34b, wherein ends of each of the torsion springs are fixedly connected to the drums 34a, respectively, and the winding position of each of the torsion springs are switchable along with different rotation directions. The drums 34a and the spools 34b mesh with each other to be moved together, and the lifting cords 16 are released or wound up by rotating the connected spools 34b.

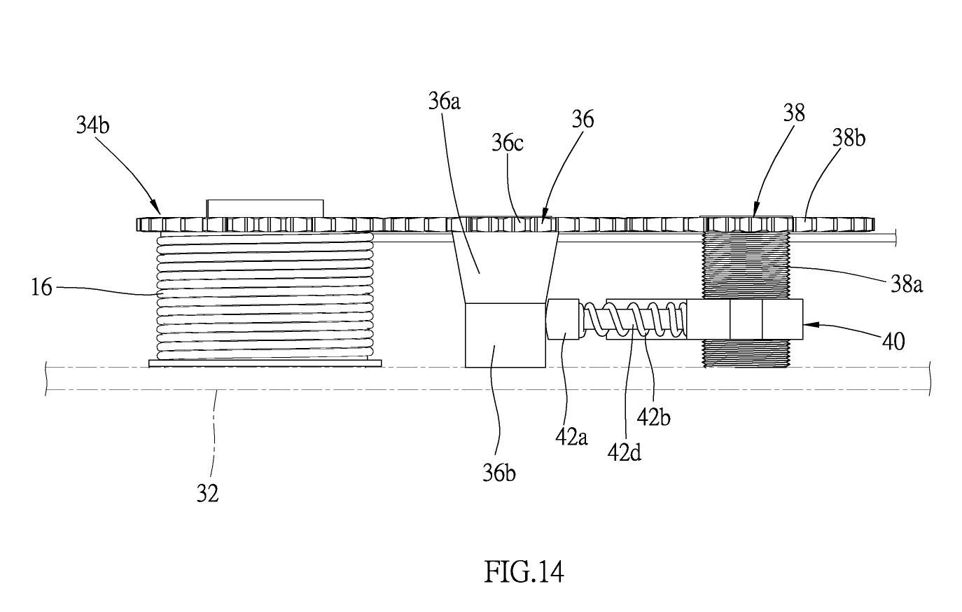

As shown in FIG. 14, the spring box further includes a post 36, a guiding member 38, a movable member 40, and a friction member 42, wherein the post 36 and the guiding member 38 are arranged in parallel, and an outer surface of the post 36 has a tapered segment, of which a diameter gradually decrease from top to bottom, and a straight segment 36b, which has a constant diameter. The post 36 has a gear 36c provided on a top thereof, which meshes with a gear provided on a top of the spool 34b adjacent the post 36, whereby the post 36 is rotatable by the rotation of the meshed spool 34b. The guiding member 38 is pivotally provided on the base 32, and is rotatable in situ. The guiding member 38 includes a bolt 38a and a gear 38b provided on a top of the bolt 38a, wherein the gear 38b of the guiding member 38 meshes with the gear 36c of the top of the post 36.

The movable member 40 has a threaded hole 40a passed by the bolt 38a, and a fin 40b provided on a lateral side thereof, wherein the fin 40b is engaged with the groove 32b on the restricting wall 32a, so that the movable member 40 would be moved along the bolt 38a when the guiding member 38 is rotated in a non-rotating manner. The movable member 40 further has a horizontal recess 40c and two positioning bores 40d, wherein the positioning bores 40d are on two sides of the recess 40c, respectively.

The friction member 42 includes a pushing block 42a, two elastic members 42b, an insertion post 42c, and two guiding posts 42d, wherein the insertion post 42c and the guiding posts 42d are provided on a side of the pushing block 42a. The elastic members 42b are springs, each of which fits around one of the guiding posts 42d. The insertion post 42c is inserted into the recess 40c of the movable member 40, and an end of each of the guiding post 42d is inserted into one of the positioning bores 40d, respectively. With the pushing force provided by the elastic members 42b, an end of the pushing block 42a abuts against the outer surface of the post 36, wherein the portion of the pushing block 42a which abuts against the post 36 is the effect portion of the friction portion defined in the present invention. However, in practice, the friction member could be designed in various ways, as long as the pushing block could abut against the post to provide friction. For example, various types of elastic members could be used to provide a pushing force for a pushing block, or the pushing block could be made of a deformable and restorable material. These designs should be deemed obvious variations, and still fall within the scope of the present invention.

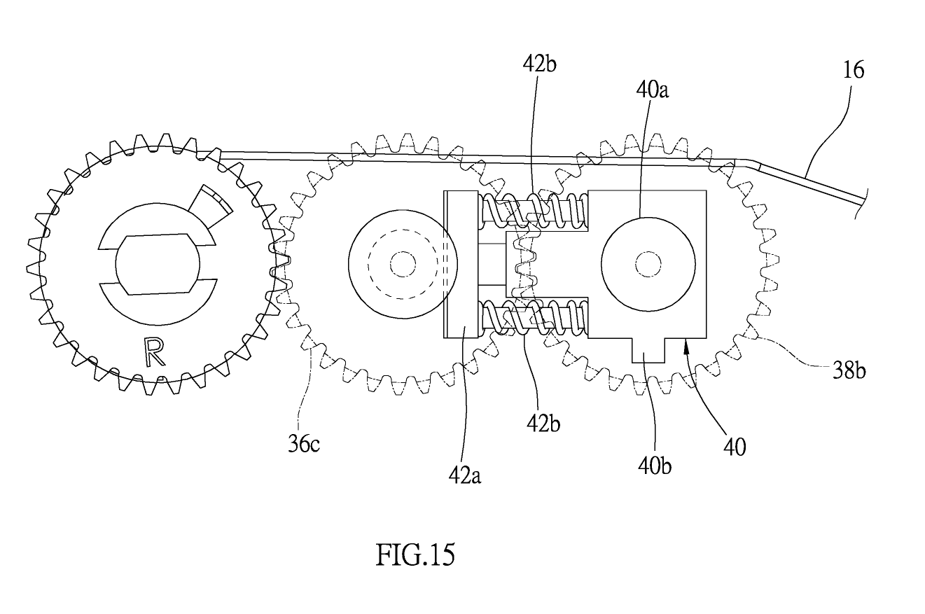

In the situation shown in FIG. 14 and FIG. 15, the lifting cords 16 are wound up, and the bottom rail 12 is near the headrail 10. At this time, the movable member 40 is close to the base 32, and the pushing block 42a of the friction member 42 abuts against the outer wall of the post 36 below the tapered segment 36a.

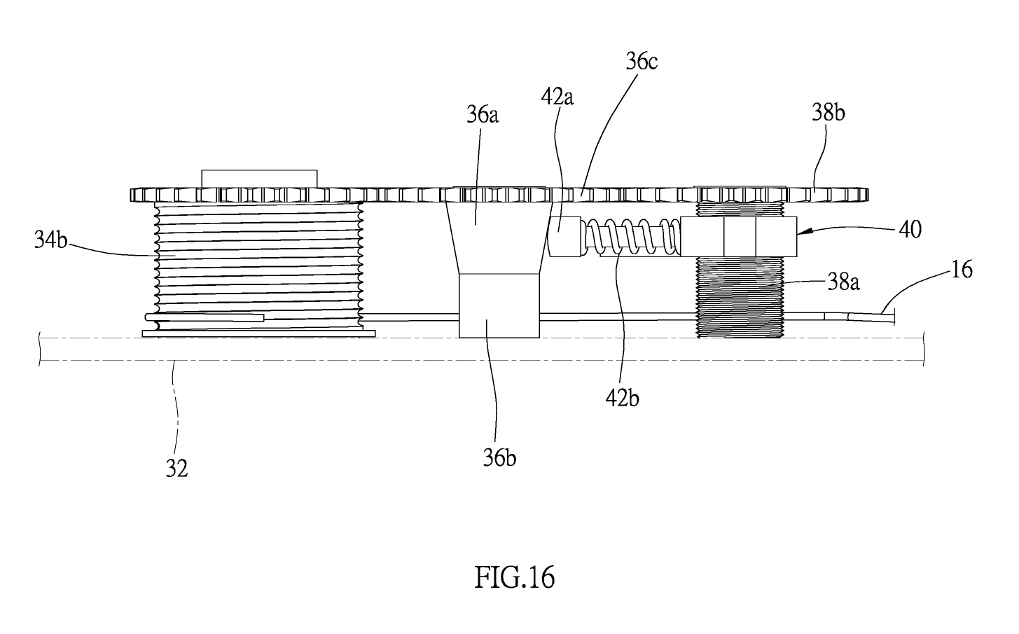

When the bottom rail 12 is pulled downward to release the lifting cords 16, the post 36 and the guiding member 38 are indirectly moved to rotate. As shown in FIG. 16, since the movable member 40 abuts against the restricting wall 32a, the movable member 40 is not rotatable, and only movable along the bolt 38a. In the third embodiment, while the bottom rail 12 is being pulled downward, the upward moving distance of the movable member 40 remains within the straight segment 36b until the bottom rail 12 reaches half way to fully expand the window covering. In other words, when the bottom rail 12 is lowered to about half way to fully expand the window covering, the pushing block 42a starts to abut against a bottom edge of the tapered segment 36a. When the bottom rail 12 is further pulled downward, and before the bottom rail 12 reaches the lowest position, the pushing block 42a shifts toward the movable member 40 due to the restriction of the tapered segment 36a, and pushes the elastic members 42b to make them deform. The further the movable member 40 is moved upward, the elastic members 42b are more deformed, which increases the friction between the pushing block 42a and the outer wall of the post 36. Whereby, the automatic rewinding force of the torsion springs and the possible rebounding force of the shield structure 14 could be suppressed, which makes the bottom rail 12 simply and exactly stay at the expected position.

On the other hand, while the bottom rail 12 is being pushed upward to raise the shield structure 14, the friction between the pushing block 42a and the outer wall of the post 36 gradually decreases. Once the bottom rail 12 reaches half way, the bottom rail 12 would be automatically pulled upward merely by the automatic rewinding force of the torsion springs to completely raise the shield structure 14. After that, the elastic members 42b would return to the original uncompressed status.

It must be pointed out that the embodiments described above are only some preferred embodiments of the present invention. All equivalent structures which employ the concepts disclosed in this specification and the appended claims should fall within the scope of the present invention.

What is claimed is:

1. A spring box of a cordless window covering, wherein the spring box is provided in one rail of the window covering; comprising:
a base;
a post rotatably connected to the base;
a prestressing device, which provides a pulling force to the post to rotate the post in a predetermined rotation direction;
a guiding member, which is rotatable by the post;
a movable member fitting around the guiding member, wherein the movable member moves along the guiding member when the guiding member is rotated; and
a friction member connected to the movable member, wherein the friction member has at least one effect portion abutting against a wall of the post; while the movable member is being moved in a predetermined direction, the at least one effect portion pushes the wall of the post harder, whereby a friction between the at least one effect portion and the wall of the post is increased.

2. The spring box of claim 1, wherein the post is a hollow tube, and has a top plate; the guiding member comprises a bolt passing through the post; a top of the bolt is connected to the top plate of the post, while a bottom of the bolt is rotatably and pivotally provided on the base; the movable member is provided in the post, and has a threaded hole being passed through by the bolt.

3. The spring box of claim 2, further comprising at least one restricting member provided in the post, wherein an end of each of the at least one restricting member is connected to the base, and each of the at least one restricting member is in parallel with the bolt; the at least one restricting member abuts against the movable member, so that the movable member moves along the bolt in a non-rotating manner when the bolt is rotated.

4. The spring box of claim 2, wherein the top plate of the post has a non-circular hole; a top of the bolt is provided with a non-circular head inserting into the non-circular hole of the top plate to be connected to the top plate.

5. The spring box of claim 2, wherein an inner wall of the post has a tapered segment, of which a diameter gradually reduces; when the movable member is moved to a top edge of the tapered segment, the friction member is compressed and deformed; when the movable member is moved to a bottom edge of the tapered segment, the friction member returns to an original status.

6. The spring box of claim 2, wherein the friction member fits around the guiding member; the at least one effect portion of the friction member comprises two effect portions, wherein one of the effect portions abuts against a lateral side of the movable member, while the other one of the effect portions abuts against the inner wall of the post.

7. The spring box of claim 1, wherein the post is in parallel with the guiding member; the guiding member comprises a bolt; a top of the bolt is connected to a top of the post, while a bottom of the bolt is rotatably and pivotally provided on the base; the movable member has a threaded hole being passed through by the bolt.

8. The spring box of claim 7, further comprising at least one restricting member adjacent to the bolt, wherein an end of each of the at least one restricting member is connected to the base, and each of the at least one restricting member is in parallel to the bolt; the at least one restricting member abuts against the movable member, so that the movable member moves along the bolt in a non-rotating manner when the bolt is rotated.

9. The spring box of claim 7, wherein an outer surface of the post has a tapered segment, of which a diameter gradually increases; when the movable member is moved to where the diameter of the tapered segment is greatest, the friction member is compressed and deformed; when the movable member is moved to where the diameter of the tapered segment is smallest, the friction member returns to an original status.

10. The spring box of claim 9, wherein the friction member comprises a pushing block and at least one elastic member; the pushing block is detachably engaged with the movable member, and has the effect portion; the at least one elastic member is provided between the pushing block and the movable member, and is deformable by compression.

11. The spring box of claim 1, wherein the movable member has an engaging portion; the at least one effect portion of the friction member comprises two effect portions, wherein one of the effect portions is engaged with the engaging portion, while the other one of the effect portions abuts against the wall of the post.

12. A friction mechanism, comprising:
a base;
a post rotatably connected to the base;
a bolt movable by the post;
a movable member having a threaded hole being passed through by the bolt;
a restricting member provided on the base, wherein the restricting member abuts against the movable member, so that the movable member moves along the bolt when the bolt is rotated; and
a friction member connected to the movable member, wherein the friction member has at least one effect portion abutting against a wall of the post; while the movable member is being moved in a predetermined direction, the at least one effect portion pushes the wall of the post harder, whereby a friction between the at least one effect portion and the wall of the post is increased.

13. The friction mechanism of claim 12, wherein the post is a hollow tube; an inner wall of the post has a tapered segment, of which a diameter gradually increases; when the movable member is moved to a top edge of the tapered segment, the friction member is compressed and deformed; when the movable member is moved to a bottom edge of the tapered segment, the friction member returns to an original status.

14. The friction mechanism of claim 13, wherein the post comprises a top plate, which has a non-circular hole; a top of the bolt is provided with a non-circular head inserting into the non-circular hole of the top plate; a bottom of the bolt is rotatably and pivotally provided on the base.

15. The friction mechanism of claim 12, wherein the post is a hollow tube; the friction member fits around the bolt; the at least one effect portion of the friction member comprises two effect portions, wherein one of the effect portions abut against a lateral side of the movable member, while the other one of the effect portions abuts against an inner wall of the post.

16. The friction mechanism of claim 12, wherein the post is parallel with the bolt; a top of the bolt is connected to a top of the post, while a bottom of the bolt is rotatably and pivotally provided on the base.

17. The friction mechanism of claim 16, wherein an outer surface of the post has a tapered segment, of which a diameter gradually increases; when the movable member is moved to where the diameter of the tapered segment is greatest, the friction member is compressed and deformed; when the movable member is moved to where the diameter of the tapered segment is smallest, the friction member returns to an original status.

18. The friction mechanism of claim 17, wherein the friction member comprises a pushing block and at least one elastic member; the pushing block is detachably engaged with the movable member, and has the effect portion; the at least one elastic member is provided between the pushing block and the movable member, and is deformable by compression.

19. The friction mechanism of claim 12, wherein the movable member has an engaging portion; the at least one effect portion of the friction member comprises two effect portions, wherein one of the effect portions is engaged with the engaging portion, while the other one of the effect portions abuts against the wall of the post.
